(19) United States
(12) Patent Application Publication
(10) Pub. No.: US 2021/0213426 A1
(43) Pub. Date: Jul. 15, 2021

(54) INORGANIC OXIDE

(71) Applicant: Sumitomo Chemical Company, Limited, Chuo-ku, Tokyo (JP)

(72) Inventors: Yoshitaka KAWAKAMI, Ehime (JP); Hiroyuki ANDO, Ehime (JP)

(73) Assignee: Sumitomo Chemical Company, Limited, Chuo-ku, Tokyo (JP)

(21) Appl. No.: 16/967,662

(22) PCT Filed: Feb. 15, 2019
(86) PCT No.: PCT/JP2019/005715

§ 371 Date: Aug. 5, 2020

(30) Foreign Application Priority Data
Feb. 15, 2018 (JP) 2018-025199

(51) Int. Cl. B01J 23/63; B01J 35/02; B01J 37/00; C01G 25/00

(52) U.S. Cl. CPC B01J 23/63; B01J 35/026; C01P 2002/70; C01G 25/006; B01J 37/0045

(57) ABSTRACT

Provided is an inorganic oxide containing Al, Ce and Zr as constituent elements and having a ratio of emission intensity I_{A} at 420 nm and emission intensity I_{B} at 470 nm (I_{B}/I_{A}) of not more than 1.65 in an emission spectrum obtained when a light at wavelength 200 nm is irradiated.

### TECHNICAL FIELD

The present invention relates to an inorganic oxide useful for supporting a catalyst metal.

### BACKGROUND ART

Catalysts for purifying exhaust gas of automobile (three-way catalyst) are generally composed of a honeycomb substrate (e.g., substrate having a honeycomb structure made of heat-resistant ceramics such as cordierite), a catalyst-supporting layer on the substrate, and a catalyst metal (e.g., noble metals such as Rh, Pd and Pt) supported on the catalyst-supporting layer.

The three-way catalysts purify exhaust gas by oxidizing hydrocarbon and carbon monoxide in the exhaust gas and reducing nitrogen oxide. To promote purification, it is known that a catalyst-supporting layer is famed using inorganic oxide containing Al, Ce and Zr as constituent elements and having oxygen storage capacity (OSC) that stores oxygen under an oxidizing atmosphere and releases oxygen under a reducing atmosphere (hereinafter sometimes to be described as “Al—Ce—Zr oxide”) (e.g., patent document 1).

### CITATION LIST

### Patent Literature

[PTL 1]

JP-A-10-202102

### SUMMARY OF INVENTION

### Problems to be Solved by the Invention

Performance improvement of catalyst (particularly three-way catalyst) is continuously required. The present invention has been made in view of such situation, and an object thereof is to provide Al—Ce—Zr oxide capable of producing a catalyst superior in performance.

### Means of Solving the Problems

The present invention achieving the above-mentioned object is as described below.

[1] An inorganic oxide comprising Al, Ce and Zr as constituent elements and having a ratio of emission intensity I_{A} at 420 nm and emission intensity I_{B} at 470 nm (I_{B}/I_{A}) of not more than 1.65 in an emission spectrum obtained when a light at wavelength 200 nm is irradiated.

[2] The inorganic oxide of [1], wherein the I_{B}/I_{A} is not more than 1.62.

[3] The inorganic oxide of [1] or [2], wherein a content of Al in the inorganic oxide is 20 to 80 wt. % in terms of Al₂O₃.

[4] The inorganic oxide of [1] or [2], wherein a content of Al in the inorganic oxide is 30 to 75 wt. % in terms of Al₂O₃.

[5] The inorganic oxide of [1] or [2], wherein a content of Al in the inorganic oxide is 40 to 65 wt. % in terms of Al₂O₃.

[6] The inorganic oxide of any one of [1] to [5], wherein a content of Ce in the inorganic oxide is 10 to 40 wt. % in terms of CeO₂.

[7] The inorganic oxide of any one of [1] to [5], wherein a content of Ce in the inorganic oxide is 15 to 35% in terms of CeO₂.

[8] The inorganic oxide of any one of [1] to [5], wherein a content of Ce in the inorganic oxide is 20 to 30 wt. % in terms of CeO₂.

[7] The inorganic oxide of any one of [1] to [8], wherein a content of Zr in the inorganic oxide is 5 to 40 wt. % in terms of ZrO₂.

[10] The inorganic oxide of any one of [1] to [8], wherein a content of Zr in the inorganic oxide is 8 to 35 wt.% in terms of ZrO₂.

[11] The inorganic oxide of any one of [1] to [8], wherein a content of Zr in the inorganic oxide is 10 to 30 wt. % in terms of ZrO₂.

[10] The inorganic oxide of any one of [1] to [11], further comprising La as the constituent element.

[13] The inorganic oxide of [12], wherein a content of La in the inorganic oxide is 0.5 to 5 wt. % in terms of La₂O₃.

[14] The inorganic oxide of [12], wherein a content of La in the inorganic oxide is 0.7 to 4 wt. % in terms of La₂O₃.

[15] The inorganic oxide of [12], wherein a content of La in the inorganic oxide is 1.0 to 3 wt. % in terms of La₂O₃.

[16] The inorganic oxide of any one of [1] to [15], wherein a ratio of maximum intensity I_{C} among all peak intensities present in 0.1 to 0.2 nm and maximum intensity I_{D} among all peak intensities present in 0.28 to 0.35 nm (I_{D}/I_{C}) in a radial distribution function obtained by Fourier transformation of an extended X-ray absorption fine structure (EXAFS) spectrum at K absorption edge of Zr in inorganic oxide is not more than 0.6.

[17] The inorganic oxide of [16], wherein the I_{D}/I_{C} is not more than 0.55.

[18] The inorganic oxide of [16], wherein the I_{D}/I_{C} is not more than 0.5.

[19] The inorganic oxide of any one of [1] to [18], which is in the form of a powder.

### Effect of the Invention

Using the inorganic oxide of the present invention, a catalyst superior in performance can be produced.

### DESCRIPTION OF EMBODIMENTS

The present invention is described below. The below-mentioned examples, preferable description and the like can be combined as long as they are not inconsistent with each other.

The inorganic oxide of the present invention contains Al, Ce and Zr as constituent elements.

The content of Al in the inorganic oxide is preferably 20 to 80 wt. %, more preferably 30 to 75 wt. %, further preferably 40 to 65 wt. %, in terms of Al₂O₃ from the aspect of imparting heat resistance. The content of Al in the inorganic oxide in terms of Al₂O₃ means the Al₂O₃ amount in inorganic oxide, converted from the amount of Al in the inorganic oxide calculated by inductively coupled plasma (ICP) atomic emission spectrophotometry and converting the value. The Al₂O₃ amount is based on the whole inorganic oxide as 100 wt. %. The same applies to the below-mentioned Ce content, Zr content, and the content of a constituent element different from Al, Ce and Zr.

The content of Ce in the inorganic oxide is preferably 10 to 40 wt. %, more preferably 15 to 35 wt. %, further preferably 20 to 30 wt. %, in terms of CeO₂ to impart oxygen storage capacity (OSC).

The content of Zr in the inorganic oxide is preferably 5 to 40 wt. %, more preferably 8 to 35 wt. %, further preferably 10 to 30 wt. %, in terms of ZrO₂ to improve OSC.

The inorganic oxide of the present invention may contain a constituent element different from Al, Ce and Zr (hereinafter sometimes to be described as “different constituent element”). Such different constituent element may be only one kind, or two or more kinds. Examples of the different constituent element include a group 2 element and a rare earth element different from Ce (hereinafter sometimes to be described as “different rare earth element”). The group 2 element and different rare earth elements may be only one kind or two or more kinds. Examples of preferable group 2 element include Sr and Ba. Examples of preferable different rare earth element include La. When the different constituent element is contained, the content thereof (when two or more kinds of constituent elements are contained, the total amount thereof) is preferably 0.5 to 5 wt. %, more preferably 0.7 to 4 wt. %, further preferably 1.0 to 3 wt. %, in terms of the oxide of the different constituent element to improve heat resistance.

The inorganic oxide of the present invention preferably further contains La as the constituent element. When La is contained, the content thereof in the inorganic oxide is preferably 0.5 to 5 wt. %, more preferably 0.7 to 4 wt. %, further preferably 1.0 to 3 wt. %, in terms of La₂O₃ to improve heat resistance.

One of the characteristics of the inorganic oxide of the present invention is a ratio of emission intensity I_{A} at 420 nm and emission intensity I_{B} at 470 nm (I_{B}/I_{A}) of not more than 1.65 in an emission spectrum obtained when a light of wavelength 200 nm is irradiated. The measurement method of the emission spectrum is as described in the below-mentioned Examples.

It is known that zirconia (ZrO₂) absorbs blue light of 450 to 495 nm when it is nanoized. For example, FIG. 1 of JP-A-2005-262069 shows that the nanosheet of zirconia shows increased absorbance at the light absorption edge of 400 nm or more as compared with a powder or a fiber of zirconia, i.e., the nanosheet of zirconia showing increased absorption of blue light.

The emission intensity ratio (I_{B}/I_{A}) of not more than 1.65 in the inorganic oxide of the present invention is assumed to be attributable to the presence of nanoized zirconia (ZrO₂) in a high dispersion state. In other words, it is assumed that the inorganic oxide of the present invention in which zirconia (ZrO₂) is present in a high dispersion state absorbs light at 470 nm, which causes I_{B}/I_{A} of not more than 1.65. The present invention is not limited by such assumption.

The present inventors confined high dispersion of zirconia in an inorganic oxide satisfying the I_{B}/I_{A}, by radial distribution function obtained by Fourier transformation of an extended X-ray absorption fine structure (EXAFS) spectrum at K absorption edge of Zr. To be specific, an inorganic oxide satisfying the I_{B}/I_{A} has a smaller ratio of maximum intensity I_{C} among all peak intensities present in 0.1 to 0.2 nm and maximum intensity I_{D} among all peak intensities present in 0.28 to 0.35 nm (I_{D}/I_{C}) in a radial distribution function obtained by Fourier transformation of an extended X-ray absorption fine structure (EXAFS) spectrum at K absorption edge of Zr in inorganic oxide than that of the inorganic oxide not satisfying the I_{B}/I_{A}. The peak present in 0.1 to 0.2 nm corresponds to Zr—O atomic distance, and maximum intensity I_{C} corresponds to the amount of 0 atom closest to Zr atom. On the other hand, the peak present at 0.28 to 0.35 nm corresponds to Zr—Zr atomic distance, and maximum intensity I_{D} corresponds to the amount of Zr atom closest to Zr atom. Thus, a small I_{D}/I_{C} means that the percentage of Zr atom closest to Zr atom is small, namely, ZrO₂ particle size being small and Zr being present in a high dispersion state in the inorganic oxide. The positions of these peaks correspond to the interatomic distances but, due to the influence of the phase shift, there may be a slight deviation between the peak position and the value of the interatomic distance.

The inorganic oxide of the present invention preferably has a ratio of maximum intensity I_{C} among all peak intensities present in 0.1 to 0.2 nm and maximum intensity I_{D} among all peak intensities present in 0.28 to 0.35 nm (I_{D}/I_{C}) in a radial distribution function obtained by Fourier transformation of an extended X-ray absorption fine structure (EXAFS) spectrum at K absorption edge of Zr in inorganic oxide of not more than 0.6. The I_{D}/I_{C} is more preferably not more than 0.55, further preferably not more than 0.5. When a peak is absent within the range of 0.1 to 0.2 nm and within the range of 0.28 to 0.35 nm and only a gentle curve (including straight line) is present, the maximum intensity values in respective ranges are taken as I_{C} and I_{D}. The measurement method of the EXAFS spectrum, and the calculation method of radial distribution function by Fourier-transformation are as described in the below-mentioned Examples.

It is known that Zr has an anchor effect to a catalyst metal such as Rh. In the catalyst obtained using the inorganic oxide of the present invention in which Zr is assumed to be present in a high dispersion state, a catalyst metal such as Rh is also assumed to be present in a high dispersion state. Therefore, using the inorganic oxide of the present invention, a catalyst superior in performance can be produced. The present invention is not limited by such assumption.

To form a catalyst-supporting layer on a honeycomb substrate by a wash coat method, the inorganic oxide of the present invention is preferably a powder.

The inorganic oxide of the present invention can be produced by a method including the following steps S1-S5:

step S1 including stirring a mixture containing metal aluminum and monovalent alcohol under refluxing to give a mixture containing aluminum alkoxide and monovalent alcohol,

step S2 including adding a zirconium compound and a cerium compound to the mixture obtained by step S1, and stirring the obtained mixture under refluxing to give a mixture containing aluminum alkoxide, monovalent alcohol, the zirconium compound and the cerium compound,

step S3 including adding water to the mixture obtained by step S2, and stirring the obtained mixture under refluxing to hydrolyze aluminum alkoxide, thus forming aluminum hydroxide to give a mixture containing aluminum hydroxide,

step S4 including drying the mixture obtained by step S3 to give a powder containing aluminum hydroxide, and

step S5 including calcining the powder obtained by step S4 to give inorganic oxide containing Al, Ce and Zr as constituent elements (hereinafter sometimes to be described as “the production method of the present invention”). Each step is described in order.

(1) Step S1

In step S1, aluminum alkoxide (Al(OR)₃) is obtained by a solid-liquid reaction of metal aluminum (Al) and monovalent alcohol (ROH) as shown by the following formula:

2Al+6ROH_{→}2Al(OR)₃+3H₂.

While metal aluminum as a material is not particularly limited, highly pure metal aluminum having a content of impurities therein such as iron, silicon, sodium, and copper, magnesium of not more than 0.01 wt. % (i.e., purity is not less than 99.99 wt. %) is preferably used. Using such highly pure metal aluminum, the obtained aluminum alkoxide does not require purification. As such highly pure aluminum, a commercially available product can be used.

The shape of metal aluminum is not particularly limited. Examples of the shape include ingot, pellet, foil, wire, and powder.

Monovalent alcohol may be only one kind or two or more kinds. From the aspect of the reactivity with metal aluminum, the carbon number of monovalent alcohol is preferably 1 to 8, more preferably 1 to 4. Examples of the monovalent alcohol include methanol, ethanol, n-propyl alcohol, isopropyl alcohol, n-butyl alcohol, sec-butyl alcohol, and tert-butyl alcohol. Among these, ethanol, n-propyl alcohol and isopropyl alcohol are preferable, and isopropyl alcohol is more preferable.

To sufficiently progress the reaction with metal aluminum, it is preferable to use an excess of monovalent alcohol in a stoichiometric ratio to metal aluminum. The mixture containing metal aluminum and monovalent alcohol may be stirred under refluxing for a time period that allows sufficient progress of the reaction thereof.

In step S1, aluminum alkoxide having an alkoxy group corresponding to the monovalent alcohol used is produced. Examples of the obtained aluminum alkoxide include aluminum ethoxide, aluminum n-propoxide, aluminum isopropoxide, aluminum n-butoxide, aluminum sec-butoxide, and aluminum t-butoxide.

The mixture containing aluminum alkoxide and monovalent alcohol obtained by step S1 may be directly used in step S2, or monovalent alcohol may be added to the mixture obtained by step S1 and the obtained diluted mixture may be used in the next step S2.

(2) Step S2

In the production method of the present invention, step S2 to give a mixture containing aluminum alkoxide, monovalent alcohol, a zirconium compound and a cerium compound needs to be performed by adding the zirconium compound and the cerium compound to the mixture obtained by step S1, and stirring the obtained mixture under refluxing. By performing step S2, inorganic oxide satisfying the I_{B}/I_{A}, wherein Zr is highly dispersed, can be obtained. The stirring time under refluxing in step S2 is preferably 0.5 to 24 hr., more preferably 1.0 to 12 hr.

Examples of the zirconium compound used in step S2 include zirconium oxyacetate, zirconium hydroxide, zirconium chloride, zirconium carbonate, zirconium nitrate, zirconium acetate, and zirconium oxalate. The zirconium compound may be an anhydride or a hydrate. The zirconium compound is preferably zirconium oxyacetate. The zirconium compound is preferably used in such an amount that the content of Zr in the obtained inorganic oxide can be within the preferable range.

Examples of the cerium compound used in step S2 include cerium acetate, cerium hydroxide, cerium chloride, cerium carbonate, cerium nitrate, and cerium oxalate. The cerium compound may be an anhydride or a hydrate. The cerium compound is preferably cerium acetate, more preferably cerium acetate monohydrate. The cerium compound is preferably used in such an amount that the content of Ce in the obtained inorganic oxide can be within the preferable range.

A component different from the zirconium compound and cerium compound (hereinafter sometimes to be described as “different component”) may be added to the mixture obtained by step S1. Such different component may be only one kind, or two or more kinds. Examples of the different component include a compound containing a group 2 element (preferably Sr or Ba) and a compound containing a different rare earth element (preferably La) (hereinafter sometimes to be described as “different rare earth element compound”). As the different component, the different rare earth element compound is preferable. When the different component is used, the amount thereof is preferably such an amount that the content of a different constituent element derived from the different component can be within the preferable range.

Examples of the compound containing a group 2 element include hydroxide, chloride, carbonate, nitrate, acetate, and oxalate each containing a group 2 element. The compound containing a group 2 element may be only one kind or two or more kinds. The compound containing a group 2 element may be an anhydride or a hydrate. The compound containing a group 2 element is preferably at least one selected from the group consisting of strontium acetate and barium acetate.

Examples of different rare earth element compound include hydroxide, chloride, carbonate, nitrate, acetate, and oxalate each containing a different rare earth element. The different rare earth element compound may be only one kind or two or more kinds. The different rare earth element compound may be an anhydride or a hydrate. The different rare earth element compound is preferably lanthanum acetate, more preferably lanthanum acetate 1.5-hydrate. The different rare earth element compound is preferably used in an amount that makes the content of the different rare earth element in the obtained inorganic oxide fall within the preferable range.

(3) Step S3

In step S3, water is added to the mixture obtained by step S2, and the obtained mixture is stirred under refluxing to hydrolyze aluminum alkoxide, thus forming aluminum hydroxide to give a mixture containing aluminum hydroxide.

To produce inorganic oxide superior in heat resistance, addition of water and refluxing thereafter are preferably performed in two steps. To be specific, a step of adding water to the mixture obtained by step S2 and stirring the obtained mixture under refluxing (hereinafter sometimes to be referred to as “step S31”), and then a step of adding water to the mixture obtained by step S31 and stirring the obtained mixture under refluxing (hereinafter sometimes to be referred to as “step S32”) is preferably performed. By performing the addition of water and stirring under refluxing thereafter in two steps, topical hydrolysis can be suppressed and aggregation of aluminum hydroxide can be prevented as compared to a case of performing the addition of water and stirring under refluxing thereafter in one step (i.e., a case of using of a large amount of water at one time). As a result, the inorganic oxide superior in heat resistance can be produced.

To prevent topical hydrolysis and the like, the amount of water to be added in step S31 is preferably 1.0 to 2.0 mol, more preferably 1.5 to 2.0 mol, per 1 mol of aluminum alkoxide.

In step S31, not only water but also a mixture of water and monovalent alcohol is preferably added to the mixture obtained by step S2. As a result, still more topical hydrolysis can be suppressed. The monovalent alcohol used for preparation of the mixture is preferably the same as the monovalent alcohol used in step S1. When a mixture of water and monovalent alcohol is added, the concentration of water in the mixture is preferably 2.0 to 40 wt. %, more preferably 5.0 to 30 wt. %.

The stirring time under refluxing in step S31 is preferably 0.2 to 24 hr., more preferably 0.4 to 12 hr.

From the aspect of sufficient hydrolysis and drying thereafter, the amount of water to be added in step S32 is preferably 1.0 to 7.0 mol, more preferably 1.5 to 3.0 mol, per 1 mol of aluminum alkoxide. A total of the amount of water to be added in step S31 and the amount of water to be added in step S32 is preferably 2.0 to 9.0 mol, more preferably 3.0 to 5.0 mol, per 1 mol of aluminum alkoxide. The stirring time under refluxing in step S32 is preferably 0.2 to 24 hr., more preferably 0.4 to 12 hr.

(4) Step S4

In step S4, the mixture obtained by step S3 is dried to give a powder containing aluminum hydroxide. Even if water (or water and monovalent alcohol) remains in the powder obtained by step S4, it is removed by calcination in the next step S5. Thus, it is not necessary to prepare a completely dry powder in step S4.

The drying in step S4 can be performed by heating and/or pressure reduction using a well known means. The drying temperature is preferably 100 to 240° C., more preferably 120 to 200° C., and the drying time is preferably 0.5 to 24 hr., more preferably 1 to 12 hr.

(5) Step S5

In step S5, the powder obtained by step S4 is calcined to give an inorganic oxide containing Al, Ce and Zr as constituent elements.

The calcination temperature is preferably 800 to 1100° C. The holding time at the calcination temperature is preferably 0.5 to 20 hr. The temperature-rising rate from room temperature to the calcination temperature is preferably 30 to 500° C./hr.

Calcination can be performed using, for example, a calcination furnace. Examples of the calcination furnace include electric furnace. The calcination container is preferably made of alumina. The calcination is preferably performed under air atmosphere.

A catalyst can be produced by supporting a catalyst metal by the inorganic oxide of the present invention according to a well-known technique. The catalyst metal is preferably rhodium (Rh). For example, a catalyst in which catalyst metal is supported can be produced by adding the inorganic oxide of the present invention to an aqueous solution of a catalyst metal salt (e.g., rhodium nitrate), maintaining the obtained mixture at a given time, and removing (e.g., evaporating) water. The catalyst metal salt is preferably used such that the supported amount of the catalyst metal in the obtained catalyst is 0.1 to 5.0 wt. % in the whole catalyst. The supported amount of the catalyst metal is more preferably 0.5 to 3.0 wt.%.

A three-way catalyst can be produced using the inorganic oxide of the present invention and according to a well-known technique (e.g., wash coat method). For example, it is possible to produce a three-way catalyst constituted of a honeycomb substrate, a catalyst-supporting layer made of the inorganic oxide of the present invention on the substrate, and a catalyst metal supported by the catalyst-supporting layer, by immersing the honeycomb substrate in an aqueous dispersion containing the catalyst metal salt and the inorganic oxide of the present invention, maintaining the same for a given time, pulling out therefrom and drying the same.

### EXAMPLES

The present invention is described in more detail in the following by referring to Examples. The present invention is not limited by the following examples, and appropriate modifications can also be added within the scope compatible with the gist described above and below, all of which are included in the technical scope of the present invention.

### Example 1

(1) Step S1

A mixture of highly pure metal aluminum with purity of not less than 99.99 wt. % (manufactured by Sumitomo Chemical Company, Limited) (189 g) and isopropyl alcohol with purity of not less than 99.9 wt. % (manufactured by JXTG Nippon Oil & Energy Corporation) (1389 g) was stirred under refluxing to give a mixture of aluminum isopropoxide (1420 g) and isopropyl alcohol (158 g).

(2) Step S2

To a total amount (aluminum isopropoxide (1420 g) and isopropyl alcohol (158 g)) of the mixture obtained by step S1 were added lanthanum acetate 1.5-hydrate (manufactured by NIKKI CORPORATION) (17 g), zirconium oxyacetate (manufactured by DAIICHI KIGENSO KAGAKU KOGYO CO., LTD.) (225 g) and cerium acetate monohydrate (manufactured by DAIICHI KIGENSO KAGAKU KOGYO CO., LTD.) (335 g) were added to give a mixture. The obtained mixture was stirred under refluxing for 60 min.

(3) Step S3

(a) Step S31

To the mixture obtained by step S2 was added a mixture of water (214 g, amount of water added to 1 mol of aluminum alkoxide: 1.7 mol) and isopropyl alcohol (1928 g) (concentration of water in mixture: 10 wt. %) to give a mixture. The obtained mixture was stirred under refluxing for 30 min.

(b) Step S32

To the mixture obtained by step S31 was added water (290 g, amount of water added to 1 mol of aluminum alkoxide: 2.3 mol) to give a mixture. The obtained mixture was stirred under refluxing for 30 min.

(4) Step S4

The mixture obtained by step S32 was dried by heating at 140° C. for 4 hr. with stirring under a nitrogen atmosphere to give a powder.

The powder obtained by step S4 was calcined using an electric furnace under air atmosphere at 1000° C. for 4 hr. (temperature-rising rate from room temperature to 1000° C.: 200° C./hr.) to give a powder of an inorganic oxide containing Ce, Zr, La and Al as constituent elements (Ce content: 26.1 wt. %, Zr content: 18.7 wt. %, La content: 1.2 wt. %, Al content: 54.0 wt. %). The contents show the amounts of oxide (i.e., CeO₂, ZrO₂, Al₂O₃ and La₂O₃) converted from the amount of each element (i.e., Ce, Zr, La and Al) obtained from inorganic oxide by ICP atomic emission spectrophotometry. The same applies to the following Comparative Example 1.

### Comparative Example 1

According to the method described in patent document 1 (particularly a method similar to Example 1), a powder of an inorganic oxide containing Ce, Zr, La and Al as constituent elements was obtained. To be specific, zirconium oxynitrate (282 g) was dissolved in water (8000 ml) and the mixture was heated to 80° C. with stirring. Thereto was added aluminum isopropoxide (1420 g), nitric acid (60 ml) was further added and stirring was continued. The whole amount of a solution of cerium nitrate 6-hydrate (434 g) and lanthanum nitrate 6-hydrate (22 g) in ethylene glycol (1000 ml) was added and the mixture was stirred at 80° C. for 48 hr. The precipitate obtained by the stirring was dried by a rotary evaporator and further dried in vacuum at 110° C. for 100 hr. The obtained powder was calcined at 950° C. for 4 hr. to give a powder of an inorganic oxide containing Ce, Zr, La and Al as constituent elements (Ce content: 26.1 wt. %, Zr content: 18.7 wt. %, La content: 1.2 wt. %, Al content: 54.0 wt.%).

<Emission Spectrum>

Using a fluorescence spectroscopy apparatus (FP-6500 manufactured by JASCO Corporation) under conditions of excitation bandwidth 5 nm, fluorescence bandwidth 1 nm, response 0.1 sec., sensitivity High, and scan rate 100 nm/min, a light (wavelength 200 nm) was irradiated on the inorganic oxide obtained in Example 1 or Comparative Example 1. Emission intensity I_{A} at 420 nm and emission intensity I_{B} at 470 nm were measured at the obtained emission spectrum, and the ratio thereof (I_{B}/I_{A}) was calculated. The results are shown in the following Table.

TABLE 1

| | | Comparative |
|---|---|---|
| | Example 1 | Example 1 |
| I_{A} | 292 | 232 |
| I_{B} | 454 | 390 |
| I_{B}/I_{A} | 1.56 | 1.68 |

<Measurement and Analysis of EXTENDED X-Ray Absorption Fine Structure (EXAFS) Spectrum>

The EXAFS spectrum at K absorption edge of Zr in the inorganic oxide obtained in Example 1 or Comparative Example 1 was measured using the XAFS measurement apparatus of the High Energy Accelerator Research Organization, Institute of Materials Structure Science, Synchrotron radiation science research facility beam line NW-10A and by a Quick XAFS method. The incident X-ray intensity (I₀) was measured at ordinary temperature using an ion chamber with a mixed gas of Ar (25% by volume) and N₂ (75% by volume), and transmission X-ray intensity (Iₜ) was measured at ordinary temperature using an ion chamber with Kr gas. The measured energy range, interval, and integration time per one measurement point were set as follows.

energy range of incident X-ray: 17494 to 19099 eV

data number: 3835 points

scantime: 300 sec.

integration: 1 time

In each incident X-ray energy (E, x axis), I₀ and Iₜ were measured, X-ray absorbance (y axis) was determined by the following formula:

X-ray absorbance mₜ=−ln(Iₜ/I₀)

and plotted on the x axis-y axis to give an X-ray absorption spectrum.

EXAFS spectrum was analyzed as follows. From the X-ray absorption spectrum obtained as mentioned above, EXAFS spectrum at K absorption edge of Zr was obtained as follows to give radial distribution function. To be specific, the obtained X-ray absorption spectrum data by the Quick XAFS method was converted to the format of EXAFS analysis software manufactured by Rigaku Corporation by “Multi File Converter” and “Multi Data Smoothing” provided by High Energy Accelerator Research Organization and a smoothing treatment was performed (smoothing conditions: Savitzky-Golay method, Points: 10, rep: 5). Then, using the analysis software (REX2000 manufactured by Rigaku Corporation), EXAFS vibration was analyzed. The energy E₀ (x axis) at K absorption edge of Zr was the energy value (x axis) at which the first-order differential coefficient in the spectrum near the K absorption edge of Zr in the X-ray absorption spectrum reaches maximum. The background of the spectrum was determined by fitting the Victoreen formula (Aλ³-Bλ⁴+C; λ is wavelength of incident X-ray, A, B, C are optional constants) to the spectrum of the lower energy range than the K absorption edge of Zr by the least squares method and deducting the background from the spectrum. Subsequently, for the spectrum, the absorbance (m₀) of the isolated atom was estimated by the Spline Smoothing method (Spline Termination1: 0.002, Spline Termination: 0.2), and the EXAFS function χ(k) was extracted. k is the wave number of photoelectron defined by 0.5123×(E−E₀)^{1/2}, and the unit of k at this time is &Aring;⁻¹. Finally, with respect to the EXAFS function k³χ(k) weighted with k³, unless otherwise specified, a radial distribution function was obtained by performing Fourier transformation in the range of k from 3.0 to 12.0&Aring;⁻¹ (Fourier-transformation conditions were as follows, FT size: 2048, Filter type: HANNING, Window width: Δk/10). The horizontal axis atomic distance of the obtained radial distribution function was unadjusted.

From the radial distribution function obtained as mentioned above, maximum intensity I_{C} among all peak intensities present in 0.1 to 0.2 nm and the maximum intensity I_{D} among all peak intensities present at 0.28 to 0.35 nm were determined, and the ratio thereof (I_{D}/I_{C}) was calculated. The results are shown in the following Table.

TABLE 2

| | | Comparative |
|---|---|---|
| | Example 1 | Example 1 |
| I_{C} | 4.95 | 5.30 |
| I_{D} | 1.83 | 4.79 |
| I_{D}/I_{C} | 0.37 | 0.90 |

<Evaluation of Catalyst Performance>

(1) Preparation of Catalyst

A powder (5 g) of the inorganic oxide obtained in Example 1 or Comparative Example 1 was added to an aqueous rhodium chloride solution (25 g) (rhodium concentration: 0.2 wt. %), and the obtained mixture was stirred at room temperature for 2 hr. and then dried at 120° C. for 12 hr. to evaporate water, and the obtained mixture was calcined in air at 600° C. for 3 hr. to prepare a catalyst powder in which Rh was supported. The supported amount of Rh was 1.0 wt. % of the whole catalyst powder.

The obtained catalyst powder (1.0 g) was cast in a cylindrical container (diameter 30 mm) for uniaxial molding and uniaxially molded under conditions of room temperature and pressure of about 20 MPa for 1 min. to give a molded product. The obtained molded product was ground in an agate mortar and the obtained ground product was sieved to prepare a sieved catalyst with a size of 100 to 180 mm.

(2) Evaluation of Catalyst Performance

The catalyst (60 mg) obtained in the above-mentioned (1) was filled in a quartz reaction tube, and a model gas having the composition shown in the following Table was flown at a space velocity (SV) of 250,000 (time⁻¹), and the gas temperature of the catalyst inlet was raised from room temperature to 600° C. at a temperature-rising rate of 60° C./min. After reaching 600° C. and the mixture was maintained at this temperature for 20 min.

TABLE 3
Model gas

| NO | CO | propylene | O₂ | H₂ | CO₂ | H₂O | N₂ |
|---|---|---|---|---|---|---|---|
| 500 | 0.5% | 400 | 0.5% | 1000 | 14% | 10% | rest |
| ppm | | ppm | | ppm | | | |

(note)
In Table 3, % and ppm are based on volume.

After the gas temperature at the catalyst inlet was maintained at 600° C. for 20 min. as mentioned above, the gas temperature at the catalyst inlet was lowered from 600° C. to 200° C. at a temperature-decreasing rate of 2.5° C./min. Contents of NO, CO and propylene in the gas before and after passing through the catalyst when the gas temperature at the catalyst inlet was 200° C. or 250° C. were measured by a total hydrocarbon analyzer (“PG-340P” manufactured by HORIBA) and a portable gas analyzer (“FIA-510” manufactured by HORIBA).

From the contents of NO, CO and propylene in the gas before and after passing through the catalyst, purification percentages of NO, CO and propylene were calculated by the following formula: purification percentage (%)=100×(content of each component in gas before passage through catalyst-content of each component in gas after passage through catalyst))/content of each component in gas before passage through catalyst. The results are shown in the following Table.

TABLE 4
Purification percentages of NO, CO and propylene

| | NO | | CO | | propylene | |
|---|---|---|---|---|---|---|
| gas temperature (° C.) | 200 | 250 | 200 | 250 | 200 | 250 |
| purification percentage (%) | 13 | 70 | 20 | 98 | 0 | 38 |
| of Example 1 | | | | | | |
| purification percentage (%) | 2 | 41 | 9 | 93 | 0 | 6 |
| of Comparative Example 1 | | | | | | |

As shown in Table 4, using the inorganic oxide of Example 1, a catalyst superior in performance can be produced as compared to the inorganic oxide of Comparative Example 1.

### INDUSTRIAL APPLICABILITY

A catalyst superior in performance can be produced from the inorganic oxide of the present invention. Therefore, the inorganic oxide of the present invention is useful for the production of, for example, a three-way catalyst.

This application is based on a patent application No. 2018-025199 filed in Japan, the contents of which are incorporated in full herein.

1. An inorganic oxide comprising Al, Ce and Zr as constituent elements and having a ratio of emission intensity I_{A} at 420 nm and emission intensity I_{B} at 470 nm (I_{B}/I_{A}) of not more than 1.65 in an emission spectrum obtained when a light at wavelength 200 nm is irradiated.

2. The inorganic oxide according to claim 1, wherein a content of Al in the inorganic oxide is 20 to 80 wt. % in terms of Al₂O₃.

3. The inorganic oxide according to claim 1, wherein a content of Ce in the inorganic oxide is 10 to 40 wt. % in terms of CeO₂.

4. The inorganic oxide according to claim 1, wherein a content of Zr in the inorganic oxide is 5 to 40 wt. % in terms of ZrO₂.

5. The inorganic oxide according to claim 1, further comprising La as the constituent element.

6. The inorganic oxide according to claim 5, wherein a content of La in the inorganic oxide is 0.5 to 5 wt. % in terms of La₂O₃.

7. The inorganic oxide according to claim 1, wherein a ratio of maximum intensity I_{C} among all peak intensities present in 0.1 to 0.2 nm and maximum intensity I_{D} among all peak intensities present in 0.28 to 0.35 nm (I_{D}/I_{C}) in a radial distribution function obtained by Fourier transformation of an extended X-ray absorption fine structure (EXAFS) spectrum at K absorption edge of Zr in inorganic oxide is not more than 0.6.

8. The inorganic oxide according to claim 1, which is in the form of a powder.
